(19) United States
(12) Patent Application Publication
(10) Pub. No.: US 2023/0086428 A1
(43) Pub. Date: Mar. 23, 2023

(54) ACTUATORS, ACCESSORIES AND AVATARS FOR ENHANCED REALITY DEVICES

(71) Applicant: Meta Platforms Technologies, LLC, Menlo Park, CA (US)

(72) Inventors: Aminata Dia, Redwood City, CA (US); Nadine Sharon Anglin, Los Angeles, CA (US); Michelle Tuyet Vo, San Francisco, CA (US); Anjali Induchoodan Menon, Redmond, WA (US); Sweta Kothari, Fremont, CA (US)

(21) Appl. No.: 17/883,411

(22) Filed: Aug. 8, 2022

Related U.S. Application Data
(60) Provisional application No. 63/247,651, filed on Sep. 23, 2021.
(60) Provisional application No. 63/247,695, filed on Sep. 23, 2021.

(51) Int. Cl. G06T 19/00; G06F 3/01

(52) U.S. Cl. CPC G06T 19/006; G06F 3/017

(57) ABSTRACT

A method for aiding users of enhanced reality headsets is provided. The method includes providing a multimedia content to a user of an enhanced reality device, adjusting a visual portion of the multimedia content for a user, based on a first user selection, adjusting an audio portion of the multimedia content for the user, and receiving a gesture input from the user in response to a query in the visual portion or the audio portion of the multimedia content. A method, for including character avatars in enhanced reality applications is also provided. The method includes determining a degree of interest of a user on a character in online content, generating a virtual interaction event between the user and an avatar for the character in online content, and providing to the user, via the enhanced reality device, the virtual interaction event with the avatar for the character in the online content.

### CROSS-REFERENCE TO RELATED APPLICATIONS

The present disclosure is related to and claims priority under 35 USC 119(e) to U.S. Prov. Appln. No. 63/247,651 entitled ACTUATORS AND ACCESSORIES FOR ENHANCED REALITY DEVICES FOR THE VISUALLY AND HEARING IMPAIRED, and to U.S. Prov. Appln. No. 63/247,695 entitled INTERACTIVE AVATARS APPEARING EPHEMERALLY ON FOLLOW, both to Aminata D I A et al, filed on Sep. 23, 2021, the contents of which applications are incorporated in their entirety by reference herein, for all purposes.

### BACKGROUND

### Field

The present disclosure is related to actuators, accessories, and avatars for enhanced reality devices. More specifically, the present disclosure is related to actuators and accessories for the visually and hearing-impaired users of enhanced reality devices, and interactive avatars appearing ephemerally on follow mode.

### Related Art

In current electronic accessories, having accessories for the visually and hearing-impaired is challenging due to the user-interface limitations of small form, carry-on devices that have now become standard items for the majority of the population. However, for those having visual or hearing impairments, the commonly available user-interfaces are impractical, leaving an entire section of the population out of reach of such devices. This situation is exacerbated for wearable devices, wherein form factor and user comfort for agility of motion further the constraints for the user interface.

The availability of enhanced reality devices that provide immersive reality experiences in virtual reality (VR) or augmented reality (AR) environments creates a wealth of opportunities to enhance the experience of users that consume multimedia online content. However, the potential of virtual or augmented reality applications associated with personalized interests of users has not quite been realized to the full extent, particularly in respect to artificial intelligence developments and three-dimensional avatar simulations.

### SUMMARY

A computer-implemented method includes providing a multimedia content to a user of an enhanced reality device, adjusting a visual portion of the multimedia content for a visually-impaired user, based on a first user selection, adjusting an audio portion of the multimedia content for a hearing-impaired user, based on a second user selection, and receiving a gesture input from the user in response to a query in the visual portion or the audio portion of the multimedia content.

A computer-implemented method includes determining a degree of interest of a user of an enhanced reality device on a person associated with a character in a multimedia online content that is publicly available for download, generating a virtual interaction event between the user of the enhanced reality device and an avatar for the person associated with the character in the multimedia online content, and providing to the user, via the enhanced reality device, the virtual interaction event with the avatar for the person associated with the character in the multimedia online content.

### BRIEF DESCRIPTION OF THE DRAWINGS

FIGS. 1A-1B illustrate users of an enhanced reality device, according to some embodiments.

FIG. 2 is a flow chart illustrating steps in a method for aiding a visually or hearing-impaired user with an enhanced reality device, according to some embodiments.

FIG. 3 is a flow chart illustrating steps in a method for providing an interactive avatar of a character in multimedia content to a user of an enhanced reality device in an immersive reality application, according to some embodiments.

FIG. 4 is a block diagram illustrating an exemplary computer system with which a headset and methods for use of the same can be implemented, according to some embodiments.

In the figures, elements having the same or similar label number share the same or similar features, unless stated explicitly otherwise.

### DETAILED DESCRIPTION

Current advances in enhanced reality devices and applications, including virtual reality (VR) and/or augmented reality (AR) make this the technology of choice for media consumption (e.g., professional media such as TV, movies, games, and other online entertainment outlets) by all segments of the population, especially young people. One sector of the population that is often neglected is the visual or hearing-impaired population. For VR/AR devices such as headsets, smart glasses, and the like, it is a challenge to provide access to immersive reality content to visual/hearing-impaired people due to the current limitations in user interface platforms.

To enhance the user experience, and to take advantage of the capabilities of enhanced reality devices, embodiments as disclosed herein allow a user to directly follow a character or actor from a TV show, film, or game downloaded by an enhanced reality device on social media, and even interact with their avatar. In some embodiments, the avatar may be an avatar associated with the character in the TV show or film itself, or the avatar of the real actor/actress interpreting the character in the TV show or film. In yet other embodiments, the avatar may be an animated figure representing a cartoon character from the TV show, film, game, and the like.

The present disclosure includes embodiments that address the above problems by including haptic actuators to provide feedback for visual/hearing-impaired users while downloading and playing online content (e.g., films, TV shows, games, and the like). Accordingly, users who are blind or deaf, or have any sort of visual/hearing impairment or incapacity, can still experience the physiological and sensory feedback of an immersive reality (AR/VR) device.

In some embodiments, making content accessible on VR/AR devices may include selecting a color contrast for displaying content, wherein a visually-impaired individual may be sensitive to the selected color contrast. In some embodiments, devices as disclosed herein may include haptic actuators for hands and fingers of users. Accordingly, visual content may be translated into Braille code through the haptic actuators and thus provide immediate translation of the visual content to individuals that may be completely blind.

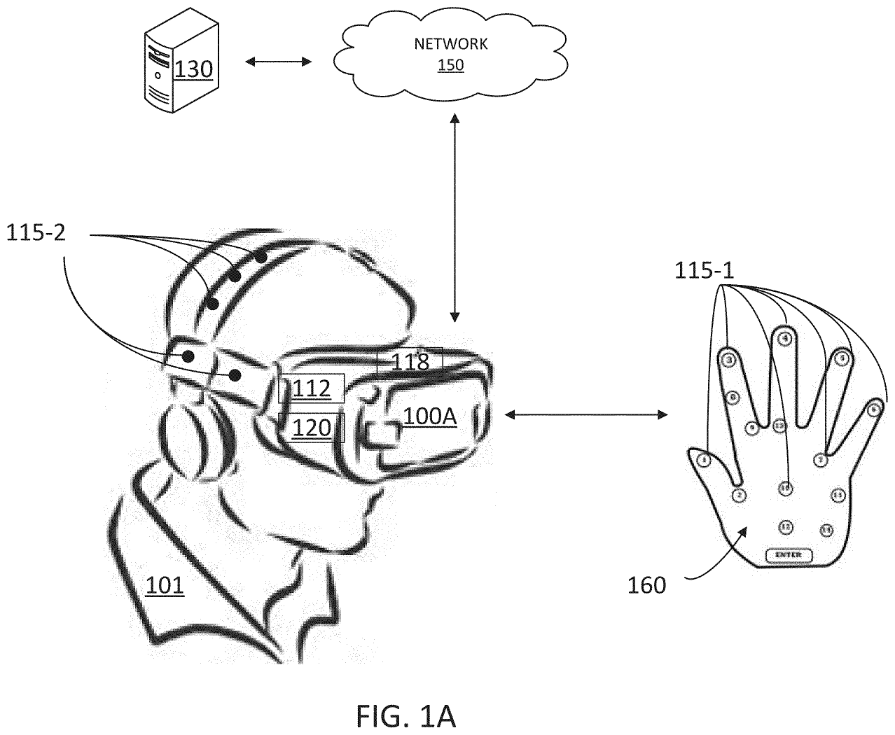

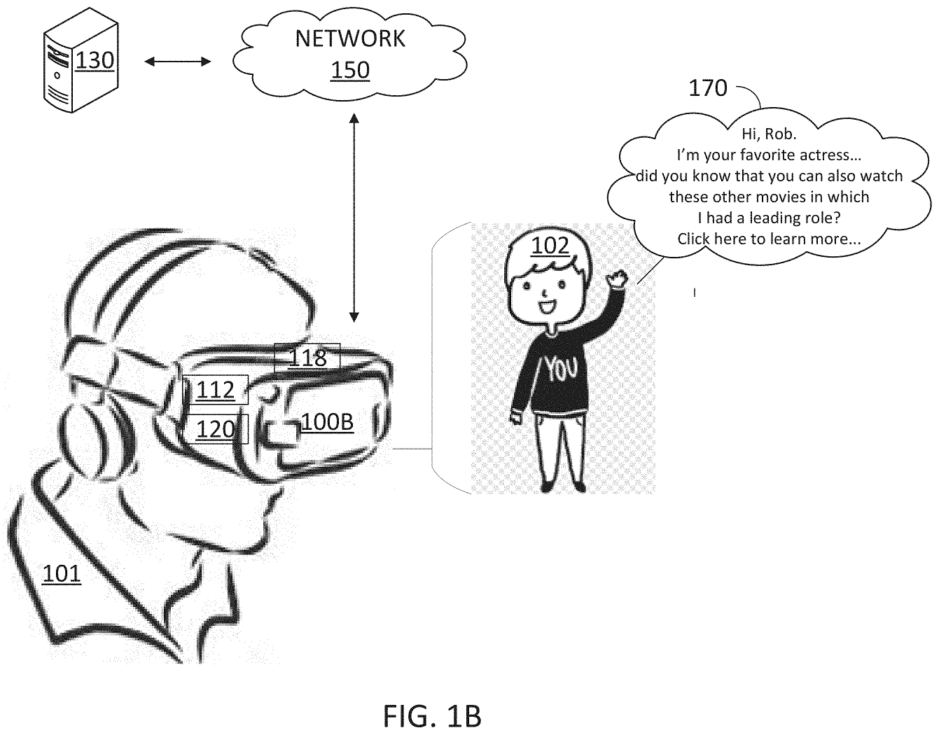

FIGS. 1A-1B illustrate user 101 of enhanced reality devices 100A and 100B (hereinafter, collectively referred to as “enhanced reality devices 100”), according to some embodiments. In addition, enhanced reality device 100 may include a memory circuit 120 storing instructions, and a processor circuit 112 configured to execute the instructions to cause enhanced reality devices 100 to perform, at least partially, some of the steps in methods consistent with the present disclosure. In some embodiments, the enhanced reality device may further include a communications module 118 enabling the device to wirelessly communicate with a remote server 130 via a network 150. Enhanced reality devices 100 may thus download a multimedia online content from the remote server, to perform at least partially some of the operations in methods as disclosed herein. Enhanced reality devices 100 may thus download a multimedia online content from remote server 130, to perform at least partially some of the operations in methods as disclosed herein.

Enhanced reality device 100A may include a headset and other wearable accessories such as actuators 115-1 in a glove 160. In some embodiments, enhanced reality device 100 may have one or more actuators 115-2 (e.g., vibrating actuators or haptic actuators) communicatively coupled with each other via an electromagnetic (EM) signal (e.g., radiofrequency signal, Wi-Fi, Bluetooth, and the like). In some embodiments, enhanced reality device 100A may include multiple sensors and microphones mounted within the frame of the headset or glove 115-1, such as motion sensors, accelerometers, gyroscopes, and cameras.

In enhanced reality device 100B, processor 112 also executes instructions to generate a virtual interaction event between user 101 and avatar 102 for a person associated with the character in the multimedia online content. In some embodiments, processor 112 also executes instructions to provide to user 101, via enhanced reality device 100B, the virtual interaction event with avatar 102 for the person associated with the character in the multimedia online content.

In some embodiments, enhanced reality device 100B may be configured to create a “moment of delight” 170, wherein once user 101 “follows” someone in a social network, their avatar 102 appears and thanks user 101 by proper name and pronouns to make user 101 feel appreciated and compensated in their attraction to a certain character or persona. In some embodiments, moment of delight 170 is a virtual interaction event between user 101 and avatar 102 for the person associated with the character in a multimedia online content.

Moments of delight 170 can be customizable. For example, when a friend follows user 101, moment of delight 170 may be different than when a co-worker follows user 101. Accordingly, the interaction of a friend's avatar 102 with user 101 may be much more intimate, humorous or informal, than between a coworker's avatar 102 and user 101 (more professional, formal, and/or circumspect).

In some embodiments, a moment of delight 170 may communicate promotions and further access to more valued material for downloading, purchase, or contract. In that regard, celebrities' avatars and/or avatars from famous personalities may be used in promotions. These configurations may bring new sources of monetization of enhanced reality devices 100 wherein celebrities, actors, sportspeople, and the like may lease their avatars for access by the public for a campaign, promotion, cameos, or any other public reach-out effort, or a personalized message from the celebrity to the user, based on a degree of an appreciation the user shows for the celebrity. For example, in some embodiments, moment of delight 170 may include an avatar of a user's favorite actor/actress saying “Hi, Rob, I'm your favorite actress, Jane Doe, did you know that you can also watch these other movies in which I had a leading role? Click here to learn more . . . .”

In some embodiments, moment of delight 170 may be interactive. For example, avatar 102 may be configured to provide different handshakes, leave a message, and the like, based on a user prompt, or in response to a certain gesture, exclamation, salutation, or any other input from the user. Some embodiments may include different interaction zones between avatar 102 and user 101 based on the degree of interest of the user on the persona, the TV show, the game, or the movie associated with the avatar. Accordingly, this may incentivize some users to be more active in their ‘likes’ and other expressions of interest or affection for a certain character, persona, show, film, game, and the like.

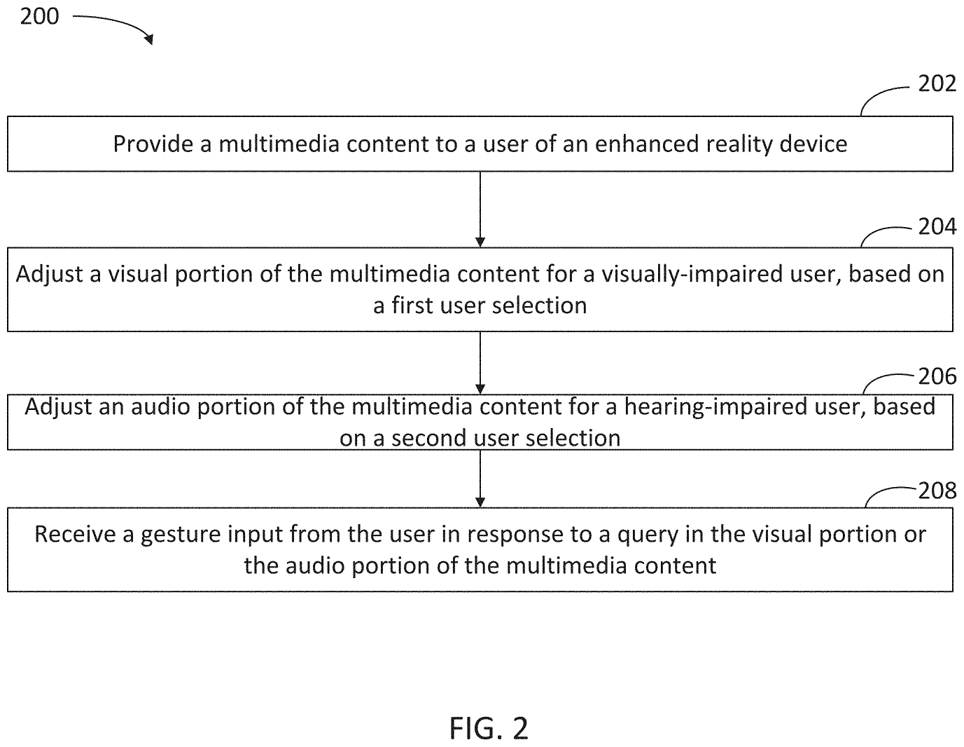

FIG. 2 is a flowchart illustrating steps in a method 200 consistent with the present disclosure. Accordingly, at least one or more of the steps in method 200 may be performed by a processor circuit executing instructions stored in a memory circuit within an enhanced reality device, as disclosed herein. In some embodiments, at least some of the steps in method 200 may be performed by a remote server, wirelessly communicating with the enhanced reality device directly or via a network. Moreover, methods consistent with the present disclosure may include at least one or more of the steps in method 200 performed in different order, simultaneously, quasi-simultaneously, or overlapping in time.

Step 202 includes providing a multimedia content to a user of an enhanced reality device.

Step 204 includes adjusting a visual portion of the multimedia content for a visually-impaired user, based on a first user selection. In some embodiments, step 204 includes selecting a color contrast in a display of the enhanced reality device based on an enhanced view for the visually-impaired user.

Step 206 includes adjusting an audio portion of the multimedia content for a hearing-impaired user, based on a second user selection. In some embodiments, the enhanced reality device includes a headset having a one or more vibrating actuators in close proximity to a skull of the hearing-impaired user, and step 206 includes providing a vibrating signal to the hearing-impaired user through the skull via the one or more vibrating actuators.

Step 208 includes receiving a gesture input from the user in response to a query in the visual portion or the audio portion of the multimedia content. In some embodiments, the enhanced reality device includes a headset communicatively coupled with a one or more haptic sensors in a glove fitting a hand of the visually-impaired user, and step 208 further includes providing a Braille translation of the visual portion of the multimedia content to the user, via the one or more haptic sensors.

Some embodiments may include vibrating actuators disposed in close proximity to the skull, in a headset, taking advantage of acoustic propagation through bone to reach the audition neural network in the brain. Accordingly, users who have limited hearing may enjoy the audio of a media download.

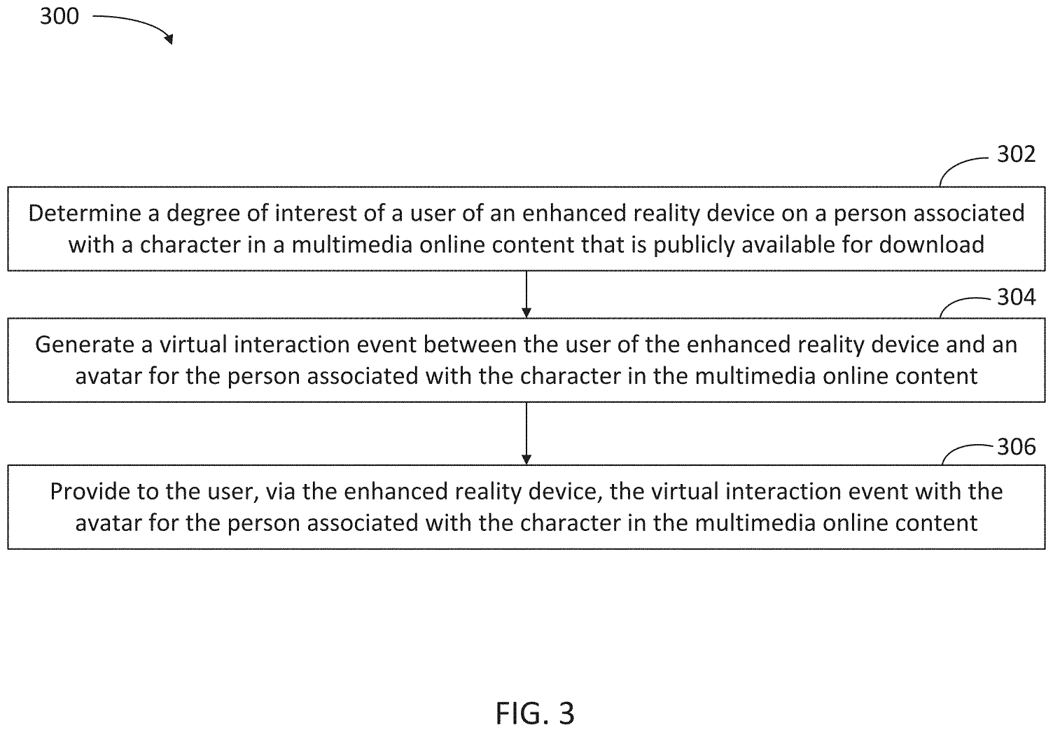

FIG. 3 is a flowchart illustrating steps in a method 300 consistent with the present disclosure. Accordingly, at least one or more of the steps in method 300 may be performed by a processor circuit executing instructions stored in a memory circuit within an enhanced reality device, as disclosed herein. In some embodiments, at least some of the steps in method 300 may be performed by a remote server, wirelessly communicating with the enhanced reality device directly or via a network. Moreover, methods consistent with the present disclosure may include at least one or more of the steps in method 300 performed in different order, simultaneously, quasi-simultaneously, or overlapping in time.

Step 302 includes determining a degree of interest of a user of an enhanced reality device on a person associated with a character in a multimedia online content that is publicly available for download. In some embodiments, step 302 includes identifying a public activity of the user in a social network wherein the user expresses an interest in the person or the character in the multimedia online content.

Step 304 includes generating a virtual interaction event between the user of the enhanced reality device and an avatar for the person associated with the character in the multimedia online content. In some embodiments, step 304 includes selecting a response from the avatar based on a cue provided by the user.

Step 306 includes providing to the user, via the enhanced reality device, the virtual interaction event with the avatar for the person associated with the character in the multimedia online content. In some embodiments, the virtual interaction event is a promotional event, and step 306 includes offering a promotion to the user, by the avatar.

### Hardware Overview

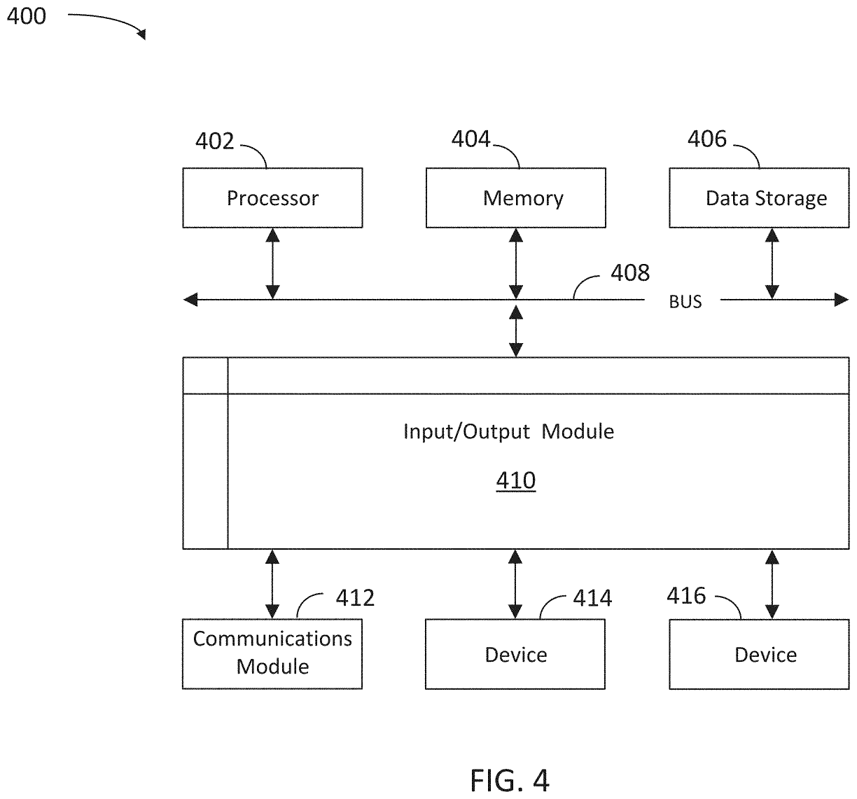

FIG. 4 is a block diagram illustrating an exemplary computer system 400 with which enhanced reality device 100 of FIG. 1, and method 200 and 300 can be implemented, according to some embodiments. In certain aspects, computer system 400 may be implemented using hardware or a combination of software and hardware, either in a dedicated server, or integrated into another entity, or distributed across multiple entities. Computer system 400 may include a desktop computer, a laptop computer, a tablet, a phablet, a smartphone, a feature phone, a server computer, or otherwise. A server computer may be located remotely in a data center or be stored locally.

Computer system 400 includes a bus 408 or other communication mechanism for communicating information, and a processor 402 (e.g., processor 112) coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404 (e.g., memory 120), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, e.g., one or more modules of computer program instructions encoded on a computer-readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled with bus 408 for storing information and instructions. Computer system 400 may be coupled via input/output module 410 to various devices. Input/output module 410 can be any input/output module. Exemplary input/output modules 410 include data ports such as USB ports. The input/output module 410 is configured to connect to a communications module 412. Exemplary communications modules 412 include networking interface cards, such as Ethernet cards and modems. In certain aspects, input/output module 410 is configured to connect to a plurality of devices, such as an input device 414 and/or an output device 416. Exemplary input devices 414 include a keyboard and a pointing device, e.g., a mouse or a trackball, by which a consumer can provide input to the computer system 400. Other kinds of input devices 414 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 416 include display devices, such as an LCD (liquid crystal display) monitor, for displaying information to the consumer.

According to one aspect of the present disclosure, wearable devices 100 can be implemented, at least partially, using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires forming bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

### Recitation of Embodiments

Embodiments as disclosed herein include any one of the following:

Embodiment I: A method that includes providing a multimedia content to a user of an enhanced reality device, adjusting a visual portion of the multimedia content for a visually-impaired user, based on a first user selection, adjusting an audio portion of the multimedia content for a hearing-impaired user, based on a second user selection, and receiving a gesture input from the user in response to a query in the visual portion or the audio portion of the multimedia content.

Embodiment II: An enhanced reality device includes a headset configured to download a multimedia content from a remote server. The headset includes a speaker to provide an audio portion of the multimedia content and a display to provide a visual portion of the multimedia content, and one or more actuators. The actuators are configured to adjust the audio portion of the multimedia content for a hearing-impaired user, based on a first user selection, and to adjust the visual portion of the multimedia content for a visually-impaired user, based on a second user selection.

Embodiment III: A method that includes determining a degree of interest of a user of an enhanced reality device on a person associated with a character in a multimedia online content that is publicly available for download, generating a virtual interaction event between the user of the enhanced reality device and an avatar for the person associated with the character in the multimedia online content, and providing to the user, via the enhanced reality device, the virtual interaction event with the avatar for the person associated with the character in the multimedia online content.

Any one of embodiments I, II, and III may be combined with the following elements, in any number, order and permutation, as follows.

Element 1, wherein adjusting a visual portion of the multimedia content includes selecting a color contrast in a display of the enhanced reality device based on an enhanced view for the visually-impaired user. Element 2, wherein the enhanced reality device includes a headset having a one or more vibrating actuators in close proximity to a skull of the hearing-impaired user, and adjusting an audio portion of the multimedia content includes providing a vibrating signal to the hearing-impaired user through the skull via the one or more vibrating actuators. Element 3, wherein the enhanced reality device includes a headset communicatively coupled with a one or more haptic sensors in a glove fitting a hand of the visually-impaired user, further including providing a Braille translation of the visual portion of the multimedia content to the user, via the one or more haptic sensors.

Element 4, wherein to adjust the visual portion of the multimedia content the display is configured with a color contrast based on an enhanced view for the visually-impaired user. Element 5, wherein the one or more actuators include a one or more haptic sensors in a glove fitting a hand of the visually-impaired user, the actuators configured to provide a Braille translation of the visual portion of the multimedia content to the visually-impaired user. Element 6, wherein the one or more actuators includes a one or more vibrating actuators in close proximity to a skull of the hearing-impaired user, the one or more vibrating actuators configured to provide a vibrating signal to the hearing-impaired user through the skull. Element 7, further including: one or more processors, and a memory storing instructions which, when executed by the one or more processors, cause the enhanced reality device to generate a virtual interaction event between a user of the enhanced reality device and an avatar for a person associated with a character in a multimedia online content. Element 8, further including one or more processors, and a memory storing instructions which, when executed by the one or more processors, cause the enhanced reality device to provide to a user of the enhanced reality device, via the enhanced reality device, a virtual interaction event with an avatar for a person associated with a character in a multimedia online content.

Element 9, wherein determining a degree of interest of a user of an enhanced reality device includes identifying a public activity of the user in a social network wherein the user expresses an interest on the person or the character in the multimedia online content. Element 10, wherein generating the virtual interaction event includes selecting a response from the avatar based on a cue provided by the user. Element 11, wherein the virtual interaction event is a promotional event, further including offering a promotion to the user, by the avatar.

What is claimed is:

1. A computer-implemented method, comprising:
providing a multimedia content to a user of an enhanced reality device;
adjusting a visual portion of the multimedia content for a visually-impaired user, based on a first user selection;
adjusting an audio portion of the multimedia content for a hearing-impaired user, based on a second user selection; and
receiving a gesture input from the user in response to a query in the visual portion or the audio portion of the multimedia content.

2. The computer-implemented method of claim 1, wherein adjusting a visual portion of the multimedia content comprises selecting a color contrast in a display of the enhanced reality device based on an enhanced view for the visually-impaired user.

3. The computer-implemented method of claim 1, wherein the enhanced reality device comprises a headset having a one or more vibrating actuators in close proximity to a skull of the hearing-impaired user, and adjusting an audio portion of the multimedia content comprises providing a vibrating signal to the hearing-impaired user through the skull via the one or more vibrating actuators.

4. The computer-implemented method of claim 1, wherein the enhanced reality device comprises a headset communicatively coupled with a one or more haptic sensors in a glove fitting a hand of the visually-impaired user, further comprising providing a Braille translation of the visual portion of the multimedia content to the user, via the one or more haptic sensors.

5. An enhanced reality device, comprising:
a headset configured to download a multimedia content from a remote server, the headset comprising:
a speaker to provide an audio portion of the multimedia content, and
a display to provide a visual portion of the multimedia content; and
one or more actuators, the actuators configured to:
adjust the audio portion of the multimedia content for a hearing-impaired user, based on a first user selection, and
adjust the visual portion of the multimedia content for a visually-impaired user, based on a second user selection.

6. The enhanced reality device of claim 5, wherein to adjust the visual portion of the multimedia content the display is configured with a color contrast based on an enhanced view for the visually-impaired user.

7. The enhanced reality device of claim 5, wherein the one or more actuators comprise a one or more haptic sensors in a glove fitting a hand of the visually-impaired user, the actuators configured to provide a Braille translation of the visual portion of the multimedia content to the visually-impaired user.

8. The enhanced reality device of claim 5, wherein the one or more actuators comprises a one or more vibrating actuators in close proximity to a skull of the hearing-impaired user, the one or more vibrating actuators configured to provide a vibrating signal to the hearing-impaired user through the skull.

9. The enhanced reality device of claim 5, further comprising:
one or more processors; and
a memory storing instructions which, when executed by the one or more processors, cause the enhanced reality device to determine a degree of interest of a user of an enhanced reality device on a person associated with a character in a multimedia online content that is publicly available for download.

10. The enhanced reality device of claim 5, further comprising:
one or more processors; and
a memory storing instructions which, when executed by the one or more processors, cause the enhanced reality device to generate a virtual interaction event between a user of the enhanced reality device and an avatar for a person associated with a character in a multimedia online content.

11. The enhanced reality device of claim 5, further comprising:
one or more processors; and
a memory storing instructions which, when executed by the one or more processors, cause the enhanced reality device to provide to a user of the enhanced reality device, via the enhanced reality device, a virtual interaction event with an avatar for a person associated with a character in a multimedia online content.

12. A computer-implemented method, comprising:
determining a degree of interest of a user of an enhanced reality device on a person associated with a character in a multimedia online content that is publicly available for download;
generating a virtual interaction event between the user of the enhanced reality device and an avatar for the person associated with the character in the multimedia online content; and
providing to the user, via the enhanced reality device, the virtual interaction event with the avatar for the person associated with the character in the multimedia online content.

13. The computer-implemented method of claim 12, wherein determining a degree of interest of a user of an enhanced reality device comprises identifying a public activity of the user in a social network wherein the user expresses an interest on the person or the character in the multimedia online content.

14. The computer-implemented method of claim 12, wherein generating the virtual interaction event comprises selecting a response from the avatar based on a cue provided by the user.

15. The computer-implemented method of claim 12, wherein the virtual interaction event is a promotional event, further comprising offering a promotion to the user, by the avatar.
